(19) United States
(12) Patent Application Publication
(10) Pub. No.: US 2024/0228379 A1
(43) Pub. Date: Jul. 11, 2024

(54) METHOD AND SYSTEM TO PRODUCE A CONCRETE MATERIAL HAVING OPTIMIZED STRENGTH AND PARTICLE PACKING PROPERTIES

(71) Applicant: SAROD GREENBACK LLP, Kolkata (IN)

(72) Inventors: Binod Kumar BAWRI, Kolkata (IN); Saroj BAWRI, Kolkata (IN); Mala BAWRI, Kolkata (IN); Raghunandan KADABA, Kolkata (IN)

(21) Appl. No.: 18/557,413

(22) PCT Filed: Jun. 14, 2021
(86) PCT No.: PCT/IB2021/055201

§ 371 Date: Oct. 26, 2023

(30) Foreign Application Priority Data
May 3, 2021 (IN) 202131020255

(51) Int. Cl. C04B 28/02; C04B 14/06; C04B 18/08; C04B 20/02; C04B 40/00

(52) U.S. Cl. CPC C04B 28/02; C04B 14/062; C04B 18/08; C04B 20/026; C04B 40/0032; C04B 40/0042; C04B 2201/52

(57) ABSTRACT

The present invention relates to a method and system to produce a concrete material having optimized strength and particle packing properties. The method and system includes a micro characterization step of a plurality of starting cementitious materials and at least one starting pozzolanic material to get respectively at least one cementitious material having uniform strength and at least one pozzolanic material having uniform blain fineness. Then grinding the said at least one cementitious material having uniform strength and the said at least one pozzolanic material having uniform blain fineness to get at least one cementitious material having a required Blaine fineness and at least one pozzolanic material having a required Blaine fineness. Finally preparing the said concrete material by mixing the said micro characterized cementitious materials and/or pozzolanic materials with at least one aggregate material, at least one additive material or a mixture thereof.

### FIELD OF THE INVENTION

The present invention relates to a method and system to produce a concrete material having optimized strength and particle packing properties. Further, the present invention relates to producing an ideal concrete material as per the structural strength requirements despite of variation in physiochemical properties of the raw materials. Furthermore, the present invention relates to a dry mix concrete material having perfect particle size distribution of a binding material.

### BACKGROUND OF THE INVENTION

The conventional method of preparing the concrete structure includes mixing of cement, fine aggregate materials and coarse aggregate materials along with other additives and then making concrete slurry with water and finally pouring this concrete slurry in the required quantity at the construction site.

Further, the physiological properties of every structure vary and many factors impact these physiological properties. The main factors include environmental conditions such as moisture/humidity, temperature, wind speed, soil profile and/or use of structure. For example, a residential building structure requires specific physiological properties, a road pavement structure requires specific physiological properties, a flyover structure requires specific physiological properties, and a structure in the sea requires specific physiological properties. As the physiological properties of the building structures vary, similarly, the concrete profile also varies.

However, in the conventional methods varied quantities of cement, fine aggregate materials and/or coarse aggregate materials and optionally additives are mixed together as per the requirements of the structure and then used. Such conventional methods only rely upon the mixing the varied quantities of cement, fine aggregate materials and/or coarse aggregate materials and optionally additives as per the structural and/or construction demand. Further, cement, fine aggregate materials and/or coarse aggregate materials also varies from place to place. Thus, it is always difficult to perfectly determine how much quantities of cement, fine aggregate materials and/or coarse aggregate materials are required to get a concrete material having specific binding properties and strength. Mostly, in the conventional methods the concrete strength is determined after hydration and solidification of concrete and then quantities of cement, fine aggregate materials and/or coarse aggregate materials are fixed.

Further, with the advancement of technology and current onsite requirements of ready to mix concrete materials, pose new challenges to provide a ready and/or dry mix concrete material having specific binding properties and strength, durability and other concrete performance criteria as per the structure requirements. Mostly, such dry mix concrete materials are prepared by conventional mixing of binding materials (cement, and/or pozzolanic material) with the aggregate materials and optionally additives. However, said binding materials (cement, and/or pozzolanic material) come in different particle sizes and in different strengths as per their source. Moreover, for industrial scale production of dry mix concrete material, it is difficult to perfectly determine the strength and particle finenesses of the cement and/or pozzolanic materials coming from with different in bulkers to our plant from cement plants in bulkers, GGBS in bulkers from steel plants, and fly ash from thermal power stations cannot be predicted, including their fineness. So, the binding materials has too many variable parameters, which will further reflect upon the process of preparing dry mix concrete materials by conventional mixing of binding materials with the aggregate materials.

Hence, there are challenges with respect to maintaining uniform quality of the ready/dry mix concrete material with least standard deviation in all parameters. Further, there are technological and economical challenges with respect to continuous optimization of existing raw materials as sourced from different plant locations and/or batches. Further, there are challenges for framing guidelines to make new types of concrete materials by analyzing the existing data.

### OBJECTIVE OF THE INVENTION

The objective of the present invention is to provide a method to produce a concrete material having optimized strength and particle packing properties.

Another objective of the present invention is to provide a system to produce a concrete material having uniform quality with least standard deviation in all parameters such as but not limited to fresh and hardened properties of a concrete material.

The main objective of the present invention is to provide a method and a system to produce a binder material having predetermined quality parameters with respect to strength, fineness and particle packing properties irrespective of the fact that each of the binder material is sourced from the different plant location and have varied strength, fineness and particle packing properties.

Another main objective of the present invention is to provide a method and a system to produce a ready/dry mix concrete material with predetermined property parameters as per the concrete structure requirements irrespective of the fact that the raw materials have varied strength, fineness and particle packing properties.

The specific objective of the present invention is micro characterization of cementitious materials of different strengths, and micro characterization of pozzolanic materials of different particle finenesses thus to provide a binder material having predictable strength and particle packing properties.

### SUMMARY OF THE INVENTION

This summary is provided to introduce a selection of concepts in a simplified format that are further described in the detailed description of the invention. This summary is neither intended to identify key or essential inventive concepts of the invention, and nor is it intended for determining the scope of the invention.

The present invention discloses a method to produce a concrete material having optimized strength and particle packing properties. The method comprises a micro characterization step of a plurality of starting cementitious materials and a micro characterization step of at least one starting pozzolanic material to get respectively at least one cementitious material having uniform strength and at least one pozzolanic material having uniform Blaine fineness or specific surface.

The micro characterization step of the plurality of starting cementitious materials comprises a strength characterization step of the plurality of starting cementitious materials, followed by a Mode Average Particle Size (MAPS) characterization step. The strength characterization of the plurality of starting cementitious materials comprises dividing the plurality of starting cementitious materials into a first cementitious material having 28 days strengths of 53-58 MPa, a second cementitious material having 28 days strengths of 58-63 MPa, and a third cementitious material having 28 days strengths of 63-70 MPa. Then mixing at least one of the first cementitious material, the second cementitious material, the third cementitious material in a ratio to get at least one cementitious material having uniform strength.

The Mode Average Particle Size (MAPS) characterization step comprises a grinding of at least one cementitious material having uniform strength to a required cement Blaine fineness.

Then grinding separately each of the said at least one cementitious material having uniform strength and the said at least one pozzolanic material having uniform Blaine fineness or specific surface to get at least one cementitious material having a required Blaine fineness and at least one pozzolanic material having a required Blaine fineness. Then finally preparing the said concrete material by mixing a material selected from at least one starting cementitious material, at least one cementitious material having uniform strength, at least one cementitious material having a required Blaine fineness, at least one starting pozzolanic material, at least one pozzolanic material having uniform blain fineness, at least one pozzolanic material having the required Blaine fineness, at least one aggregate material, at least one additive material or a mixture thereof.

The micro characterization step of at least one starting pozzolanic material comprises a pozzolanic Blaine fineness characterization step, followed by a Mode Average Particle Size (MAPS) characterization step. The pozzolanic Blaine fineness characterization step comprises dividing at least one starting pozzolanic material into a first pozzolanic material having Blaine fineness of 2500-3500 cm²/gm, a second pozzolanic material having Blaine fineness of 3500-5000 cm²/gm, a third pozzolanic material having Blaine fineness of 5000-6500 cm²/gm. Then mixing the first pozzolanic material, the second pozzolanic material, the third pozzolanic material in a ratio to get at least one pozzolanic material having uniform Blaine fineness. The MAPS characterization step comprises a grinding of at least one pozzolanic material having uniform Blaine fineness to a required Blaine fineness of at least one pozzolanic material.

The present invention discloses a system to produce a concrete material having optimized strength and particle packing properties. The system comprises a cement micro characterization unit, a pozzolanic micro characterization unit, at least one grinding unit and or a concrete mixing unit. The cement micro characterization unit provides at least one cementitious material having uniform strength from a plurality of starting cementitious materials. The pozzolanic micro characterization unit provides at least one pozzolanic material having uniform blain fineness from at least one starting pozzolanic material.

The at least one grinding unit is provided for grinding the said at least one cementitious material having uniform strength and the said at least one pozzolanic material having uniform blain fineness to get at least one cementitious material having a required Blaine fineness and at least one pozzolanic material having a required Blaine fineness. The concrete mixing unit is adapted to mix a material selected from at least one starting cementitious material, at least one cementitious material having uniform strength, at least one cementitious material having a required Blaine fineness, at least one starting pozzolanic material, at least one pozzolanic material having uniform blain fineness, at least one pozzolanic material having a required Blaine fineness, at least one aggregate material, at least one additive material or a mixture thereof.

The cement micro characterization unit includes a cement strength characterization unit, a cement mixing unit, and a cement Mode Average Particle Size (MAPS) characterization unit. The cement strength characterization unit includes a plurality of dividing units each dividing the plurality of starting cementitious materials into a first cementitious material having 28 days strength of 53-58 MPa, a second cementitious material having 28 days strength of 58-63 MPa, and a third cementitious material having 28 days strength of 63-70 MPa. The cement mixing unit includes a mixer such as a continuous mixer to mix at least one of the first cementitious material, the second cementitious material, the third cementitious material in a ratio to get at least one cementitious material having uniform strength.

The cement Mode Average Particle Size (MAPS) characterization unit comprises a first grinding unit deployed for grinding the at least one cementitious material having uniform strength to a required cement Blaine fineness. Wherein, the required cement Blaine fineness is selected from a first cement Blaine fineness of 2500-3800 cm²/gm, a second cement Blaine fineness of 11000-15000 cm²/gm, a third cement Blaine fineness of 30000-50000 cm²/gm.

The pozzolanic micro characterization unit includes a pozzolanic Blaine fineness characterization unit, a pozzolanic mixing unit and a pozzolanic Mode Average Particle Size (MAPS) characterization unit. The pozzolanic Blaine fineness characterization unit includes a plurality of dividing units each dividing the plurality of starting pozzolanic materials into a first pozzolanic material having Blaine fineness of 2500-3500 cm²/gm, a second pozzolanic material having Blaine fineness of 3500-5000 cm²/gm, a third pozzolanic material having Blaine fineness of 5000-6500 cm²/gm. The pozzolanic mixing unit includes a mixer such as a continuous mixer to mix at least one of the first pozzolanic material, the second pozzolanic material, the third pozzolanic material in a ratio to get at least one pozzolanic material having uniform Blaine fineness.

The pozzolanic Mode Average Particle Size (MAPS) characterization unit includes a second grinding unit deployed for grinding of at least one pozzolanic material having uniform Blaine fineness to a required Blaine fineness of at least one pozzolanic material. Wherein, the required Blaine fineness of at least one pozzolanic material is selected from a first Blaine fineness of 2500-6000 cm²/gm, a second Blaine fineness of 11000-15000 cm²/gm, and a third Blaine fineness of 30000-50000 cm²/gm.

The first grinding unit and the second grinding unit are one of a ball mill, a rod mill, a vibrating bed mill, or an agitator bed mill.

The concrete mixing unit is a site mixer, or a designed mixing cum pumping unit.

Wherein, at least one starting cementitious material, at least one cementitious material having uniform strength, at least one starting pozzolanic material, at least one pozzolanic material having uniform Blaine fineness, at least one aggregate material, at least one additive material, wherein each have a separate storage unit.

In an embodiment, the concrete material having optimized strength and particle packing properties and workable rheology is conveyed from the concrete mixing unit to a construction site through a screw conveyor system or a manual placement method.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE FIGURES

These and other features, aspects, and advantages of the present invention will become better understood when the following detailed description is read with reference to the accompanying figures in which like characters represent like parts throughout the figures, wherein:

FIG. 1 illustrates a flow diagram for producing a cementitious material having perfect particle packing scenario;

FIG. 2 illustrates a pozzolanic material having perfect particle packing scenario;

FIG. 3 illustrates a flow diagram for producing a concrete material having optimized strength and particle packing properties as per the method and system of present invention; and

FIG. 4 illustrates a schematic representation of micro characterization of cementitious materials and micro characterization of pozzolanic materials.

Further, skilled artisans will appreciate that elements in the figures are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a composition comprises a list of ingredients does not include only those ingredients, but may include other ingredients not expressly listed. Similarly, process or method that comprises a list of steps does not include only those steps but may include other steps not expressly listed or inherent to such process or method.

Unless otherwise defined, all technical and scientific terms used herein have the same meaning as commonly understood by one of ordinary skill in the art to which this invention belongs. The system, methods, and examples provided herein are illustrative only and not intended to be limiting.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The term “strength” or “compressive strength” of concrete is the most common performance measure used by the engineer in designing buildings and other structures. The compressive strength is measured by breaking cylindrical concrete specimens in a compression-testing machine. The compressive strength is calculated from the failure load divided by the cross-sectional area resisting the load and reported in units of pound-force per square inch (psi) in US Customary units or Mega Pascal (MPa) in SI units.

The mode average particle diameter as provided herein is understood to be the peak of the particle frequency distribution curve, obtained from PSD analysis. In simple words, the mode is the highest peak seen in the particle frequency distribution curve. The mode represents the particle size (or size range) most commonly found in the particle frequency distribution curve.

The smallest fine and coarse aggregate mode average particle diameter is termed herein as the mode average particle diameter of the particles present in the raw construction material. The smallest fine and coarse aggregate mode average particle diameter thus provides a clear-cut idea of lattice void fillers being size of the particle of the raw construction material.

Further, the particle-size distribution (PSD) analysis is termed herein as the mathematical expression of finding about the ratio/proportion of various particle size ranges which are present in given raw construction material. Generally, volume, area, length, and quantity are used as standard dimensions for determining the particle amount present in the raw construction material. However, the volume of the raw construction material sample is considered as the easiest dimension and/or way of finding out the ratio of various particles size ranges present in the given raw construction sample.

Embodiments of the present invention will be described below in detail with reference to the accompanying figures.

The present invention provides a method and a system to produce a concrete material having optimized strength and particle packing properties. The present invention also provides a method and system to produce a ready/dry mix concrete material having perfect particle size distribution of a binding material.

Further, the present invention provides a method and system to produce a perfect binding material with uniform particle size distribution.

Further, the present invention provides a method and system to use pozzolanic materials for producing a ready/dry mix concrete material having optimized strength and particle packing properties.

The present invention provides a method and system to produce ready/dry mix concrete material as per the construction/structure demand with predetermined strength and particle packing property despite of variation in the particle size and/or Blaine fineness of the binder materials sourced from different locations/plants.

The method of the present invention includes a micro characterization step of a plurality of starting cementitious materials and a micro characterization step of at least one starting pozzolanic material to get respectively at least one cementitious material having uniform strength and at least one pozzolanic material having uniform blain fineness.

The binding materials as referred hereinabove include cementitious materials and/or pozzolanic materials. Wherein, the said binding materials come with different grades having different particle sizes, and/or different strengths and also vary from plant to plant as well as location to location. The cement from one plant location has different particle size and strength when compared to cement from another plant location. Similarly, the pozzolanic materials such as GGBS, fly ash from one plant location have different particle size and/or Blaine fineness when compared to pozzolanic materials from another plant location. However, said binding materials are counted as the main base materials for concrete preparation and mainly the concrete strength and other physiological properties are determined from the said base materials.

Further, it is always difficult to ascertain the physiochemical properties of these binding materials because even one batch different from the next batch for the same plant location.

Accordingly, the micro characterization step as disclosed herein fixes the physiochemical properties of said binding materials despite of the fact that each batch of the said binding materials has varied physiochemical properties.

To ascertain the uniform quality of the final concrete material, the particle size and/or Blaine fineness as well as strength of the said binding materials need to be fixed. However, it is difficult to determine which property needs to be fixed for which binding material.

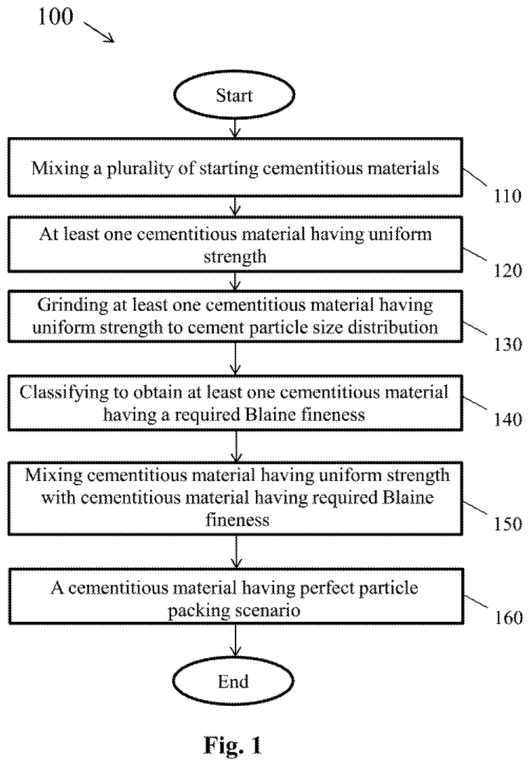

Accordingly, as illustrated in FIG. 1, the micro characterization step of the plurality of starting cementitious materials includes a strength characterization step of the plurality of starting cementitious materials (110-120), followed by a Mode Average Particle Size (MAPS) characterization step (130-160).The strength characterization of the plurality of starting cementitious materials comprises dividing the plurality of starting cementitious materials into a first cementitious material having 28 days strengths of 53-58 MPa, a second cementitious material having 28 days strengths of 58-63 MPa, and a third cementitious material having 28 days strengths of 63-70 MPa. Then mixing (110) at least one of the first cementitious material, the second cementitious material, the third cementitious material in a ratio to get at least one cementitious material having uniform strength (120).

Cement PSD usually contains a multiple particle size system, characterized by its PSD. But while we study the PSD, it is evident that the frequency distribution curve has a peak around one single, or a range of particle size, around which maximum number of particles are present in the system. This aspect creates a lot of voids or void percentage in the system, which ultimately creates more porosity in the system. Hence, we determine the % voids in the system as well as the MODE size of the voids by a simple mathematical approach, and designate this determined void size as the Mode Average Particle Size (MAPS) of the next volume/weight % of particles to fill in the voids. We then subject the cementitious material to a grinding process, to obtain a second set of cementitious particles, whose MAPS derived from the peak point in the PSD curve of the ground sample corresponds to the mathematically determined MAPS of the void system. Hence, this determined volume/weight % of the ground material is mixed with the original material in the calculated proportion, to obtain a denser packing of the cementitious matrix. The same procedure is repeated to further grind the second size material, to obtain a third size fraction which fits into the voids of the second size fraction. This creates a densely packed matrix by adopting a multi-system packing approach.

In an embodiment, the Mode Average Particle Size (MAPS) characterization step includes grinding of at least one cementitious material having uniform strength to a required cement Blaine fineness (130). Then classifying the grinded at least one cementitious material having uniform strength, wherein, the said classification is based on the Particle Size Distribution (PSD) (140). Wherein, such classification provides a plurality of cementitious materials having different Particle Size Distribution.

In another embodiment, the plurality of cementitious materials having different Particle Size Distribution are then again grinded to get a cementitious material having required Blaine fineness.

In another embodiment, the grinding, classification steps are repeated again and again till a cementitious material having required Blaine fineness is achieved.

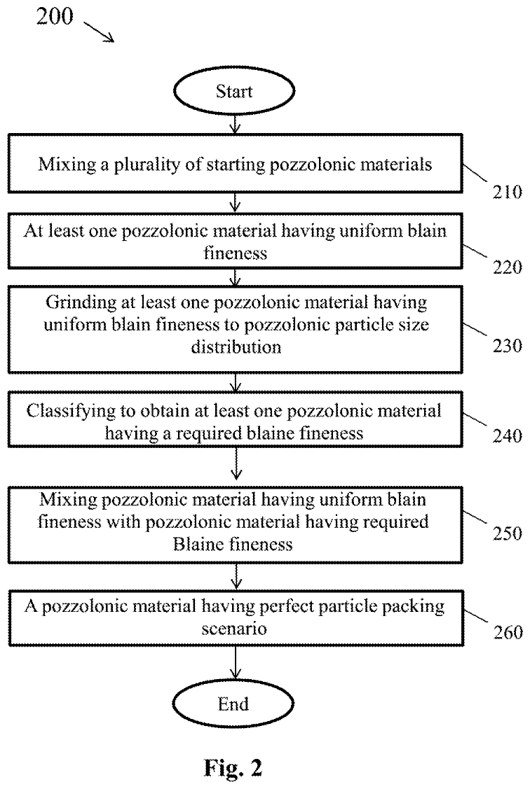

Further, as illustrated in FIG. 2, the micro characterization step of at least one starting pozzolanic material includes a pozzolanic Blaine fineness characterization step (210-220), followed by a Mode Average Particle Size (MAPS) characterization step (230-260).The pozzolanic Blaine fineness characterization step comprises dividing at least one starting pozzolanic material into a first pozzolanic material having Blaine fineness of 2500-3500 cm²/gm, a second pozzolanic material having Blaine fineness of 3500-5000 cm²/gm, a third pozzolanic material having Blaine fineness of 5000-6500 cm²/gm. Then mixing (210) the first pozzolanic material, the second pozzolanic material, the third pozzolanic material in a ratio to get at least one pozzolanic material having uniform Blaine fineness (220). The Mode Average Particle Size (MAPS) characterization step comprises a grinding (230) of at least one pozzolanic material having uniform Blaine fineness to a pozzolanic material having required Blaine fineness.

In an embodiment, the Mode Average Particle Size (MAPS) characterization step includes grinding of at least one pozzolanic material having uniform Blaine fineness. Then classifying (240) the grinded at least one pozzolanic material having uniform Blaine fineness, wherein, the said classification is based on the Particle Size Distribution (PSD). Wherein, such classification provides a plurality of pozzolanic materials having different Particle Size Distribution.

In another embodiment, the plurality of pozzolanic materials having different Particle Size Distribution (PSD) are then again grinded to get a pozzolanic material having required Blaine fineness.

In another embodiment, the grinding, classification steps are repeated again and again till a pozzolanic material having required Blaine fineness is achieved.

The PSD of pozzolanic materials usually contain a sparsely diverse multiple particle size system, characterized by its PSD. Again, while we study the PSD of pozzolanic materials, it is evident that the frequency distribution curve has a peak around one single, or a range of particle size, around which maximum number of particles are present in the system. This aspect creates a lot of voids or void percentage in the system, which ultimately creates more porosity in the system. Hence, we determine the % voids in the system as well as the MODE size of the voids by a simple mathematical approach, and designate this determined void size as the Mode Average Particle Size (MAPS) of the next volume/weight % of particles to filled in the voids. We then subject the pozzolanic material to a grinding process, to obtain a second set of pozzolanic material, whose MAPS derived from the peak point in the PSD curve of the ground sample corresponds to the mathematically determined MAPS of the void system. Hence, this determined volume/weight % of the ground material is mixed with the original material in the calculated proportion, to obtain a denser packing of the pozzolanic material matrix. The same procedure is repeated to further grind the second size material, to obtain a third size fraction which fits into the voids of the second size fraction. This creates a densely packed matrix by adopting a multi-system packing approach.

Finally the concrete material is prepared by mixing a material selected from at least one starting cementitious material, at least one cementitious material having uniform strength, at least one cementitious material having required Blaine fineness, at least one starting pozzolanic material, at least one pozzolanic material having uniform blain fineness, at least one pozzolanic material having required Blaine fineness, at least one aggregate material, at least one additive material or a mixture thereof.

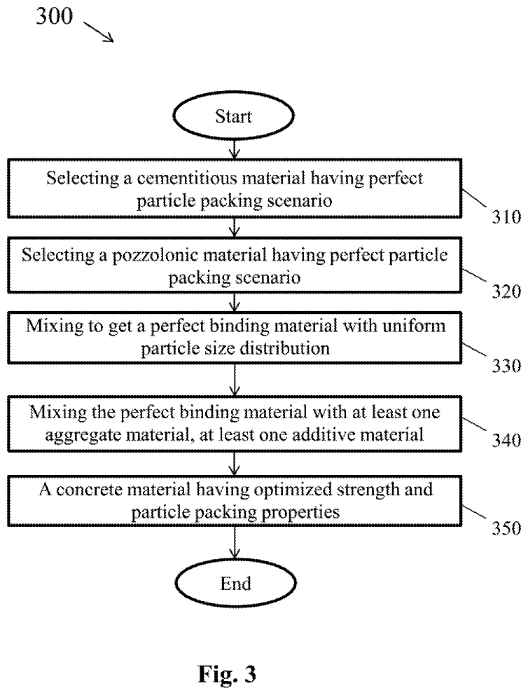

As illustrated in FIG. 3, firstly a cementitious material is selected having perfect particle packing scenario (310), then a pozzolanic material is selected having perfect particle packing scenario (320). Then both are mixed together to get a perfect binding material with uniform particle size distribution (330). Then the said perfect binding material is mixed (340) with at least one aggregate material, at least one additive material to obtain a concrete material having optimized strength and particle packing properties (350).

The method as disclosed in the present invention, wherein, the at least one starting pozzolanic material is selected from a fly ash material, a slag material, a volcanic ash material, metakaoline, ground quartz material, rice husk ash, organic ash, inorganic ash or a mixture thereof.

The method as disclosed in the present invention, wherein, the said at least one additive material is selected from a group of lignosulphonate, polycarboxylic acid, melamine, sulphonated naphthalene formaldehyde.

The method as disclosed in the present invention, wherein, the said at least one aggregate material is selected from one of a fine aggregate material, a coarse aggregate material, a silica coated coarse aggregate material, or a rapid coated aggregate material.

The method as disclosed in the present invention, wherein, the silica coated coarse aggregate material comprises coarse aggregate material coated with a slurry of silica to form a silica coating thereon.

The method as disclosed in the present invention, wherein, the slurry of silica is selected from a slurry of micro silica, or a slurry of nano silica.

The method as disclosed in the present invention, wherein, the rapid coated aggregate material comprises a mixture of a bone dried aggregate material coated/mixed with a first slurry made of at least one starting cementitious material, at least one cementitious material having uniform strength, at least one starting pozzolanic material, at least one pozzolanic material having uniform Blaine fineness, and at least one additive material and mixing water.

The method as disclosed in the present invention, wherein, the said bone dried aggregate material is selected from one of a fine aggregate material, a coarse aggregate material, a silica coated coarse aggregate material. The silica coating of coarse aggregates is to facilitate a stronger Inter facial transition zone between the aggregate and mortar matrix which exponentially increases the strength and durability properties concrete, irrespective of its aggregate/binder ratio.

### EXAMPLES

In an exemplary embodiment, the cement from one plant/batch/grade is denoted with CA, wherein, CA having strength range of 53-58 MPa. The cement from another plant/batch/grade is denoted with CB, wherein, CB having strength range of 58-63 MPa. The cement from another plant/batch/grade is denoted with CC, wherein, CC having strength range of 63-70 MPa.

Further, these cement materials with different strengths have little variation in terms of their Blaine fineness because mostly, the Blaine fineness of cement lies in the band of 2500-3500 Blaines, or 3000-3800 Blaines, as the cement industry follows the Blaine fineness standard for 43/53 grade cements.

### Concrete Requirement for Construction Site 1

A concrete requirement comes from construction site 1, that they need two types of concretes for a particular project with the following requirements:
Concrete type 1: (for sub structures, below ground)
   1. Compressive strength at 28 days to be exactly 50 MPa;
   2. Compressive strength at 3 days—Not important;
   3. RCPT value to be very low, that is between 100 to 1000 coulombs;
   4. Sulphate resistance required—High;
   5. Water permeability should be below 10 mm.
Concrete type 2 (for superstructure in the same building):
   1. Compressive strength of concrete at 28 days 50 MPa;
   2. Compressive strength at 3 days-30 MPa;
   3. RCPT value—1000-2000 coulombs;
   4. Sulphate resistance required—Not important;
   5. Water permeability—less than 25 mm.

Now, for the same project, we need two different types of concretes. Accordingly, the method and system as disclosed in the present invention is capable of producing these two different types of concretes.

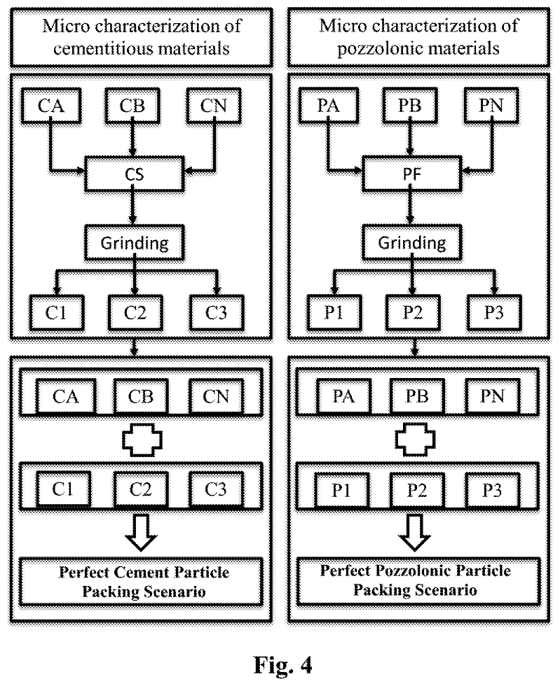

In an embodiment and according to FIG. 4, the starting cementitious materials are taken from number of different sources e.g. CA, CB, CN and similarly the starting pozzolanic materials are taken from number of different sources such as PA, PB, PN.

In an exemplary embodiment, the starting cementitious materials are taken from three or more different sources e.g. CA, CB, CN and similarly the starting pozzolanic materials are taken from three or more different sources such as PA, PB, PN.

As illustrated in FIG. 4, the cementitious materials as taken from three or more different sources e.g. CA, CB, CN are mixed in equal weight percent ratios to get a cementitious material having uniform strength (CS) i.e. the average of the strength of all three cementitious materials. Then the cementitious material having uniform strength (CS) is grinded and classified to further get cementitious materials C1, C2, and C3 each having different Blaine fineness. Further, the cementitious material having uniform strength (CS) in 70 weight percent is taken and at least one of cementitious materials C1, C2, and C3 is taken in 30 weight percent to get a cement material with perfect strength and particle packing scenario.

Then the pozzolanic materials as taken from three or more different sources e.g. PA, PB, PN are mixed in equal weight percent ratios to get a pozzolanic material having uniform Blaine fineness (PF) i.e. the average of the Blaine fineness of all three pozzolanic materials. Then the pozzolanic material having Blaine fineness (PF) is grinded and classified to further get pozzolanic materials P1, P2, and P3 each having different Blaine fineness. Further, the pozzolanic material having uniform Blaine fineness (PF) in 70 weight percent is taken and at least one of pozzolanic materials P1, P2, and P3 is taken in 30 weight percent to get a pozzolanic material with perfect strength and particle packing scenario.

Now, for this particular case example above, and for concrete type 1, where the concrete requirement is a strength of 50 MPa for the foundation, and RCPT 100-1000, permeability also less, that is, less than 10 mm etc, and the early strength is not important.

Thus, a higher fly ash concrete is required for getting the required later age strength, and lower RCPT and permeability values etc. Accordingly, the concrete with the following recipe is designed:

Concrete Binder(B)=Cementitious materials(C)+Pozzolanic materials(P).

Where, CS+C1+C2+C3=70% by weight of Concrete Binder (B)=C total, where, CS always has a fixed strength (which is the average of CA, CB, CN), and CS always is 70% by weight of C total, C1 always has a fixed strength and Blaine's fineness, achieved by the above simple method, and C1% is always about 20% by weight of C total, C2 always has another fixed strength and Blaine's fineness, achieved by the above simple method, and C2 is always 5% by weight of C total, C3 always has a fixed strength and Blaine's fineness, achieved by the above simple method, and C3 always is about 1-2% by weight of C total.

Similarly, where PF+P1+P2+P3=30% by weight of binder (B)=P total, where, PF always has a fixed strength parameter (based on lime reactivity test from the source of fly ash, which is always same) and fixed fineness, and PF is always 70% by weight of P total P1 also has a fixed fineness and strength based on the above method of classification and ball mill, and P1 is always about 20% by weight of P total. The same applies for P2 as well as P3.

Now, with all these fixed parameters, the present method and system can ensure that the concrete strength is always the same, for different combinations of C:P, and particle packing is always ensured to the best, in whichever combination of C:P is used.

In another embodiment, the method and system of the present invention uses a concrete property database or binder database (table 1) for various combinations of C:P, which is 100:0, 90:10, 80:20 . . . 30:70, where C is average of CA, CB, CN, and P is average of PA, PB, PN and wherein CA is the representative sample of the strength range 53-58 MPa, CB is a representative sample of strength range 58-63 MPa, and CN is a representative sample from the market, of strength range 63-70 MPa. The said database ensures that the strength of various concrete materials is always definitely predictable. Further, the particle packing of the concrete material is always the same, and the best. Further, the concretes for selected C:P ratios can be easily casted out for different applications, to have the fixed strength and durability parameters similar as in the database.

Accordingly, for concrete type 1, the concrete with a binder of C:P as in the ration 70:30% is prepared (which always has the same predictable strength, with a/b ratio and w/b ratio appropriately), to get the required strength and durability parameters as needed by the customer.

For the concrete type 2 requirement, the concrete with a binder of C:P as in the ration 100:0, or 90:10 is prepared (which always has the same predictable strength, with a/b ratio and w/b ratio appropriately), to get the required strength and durability parameters as needed by the customer

In another embodiment, the fixed database of binders ensures perfect selection of ratios of C:P for making concretes for specific purposes with specific physiological properties.

TABLE 1
The binder database

| | Bind- | Ce- | Fly | Micro | | A/B ratio OR |
|---|---|---|---|---|---|---|
| S. | er | ment - C | ash - P | silica | w/b | AGGREGATE |
| No. | Name | (%) | (%) | (%) | ratio | TYPE |
| 1 | B1 | 100 | 0 | 0 | x | 1 |
| | B1A | 100 | 0 | 0 | x + 0.01 | 1 |
| | B1B | 100 | 0 | 0 | x − 0.01 | 1 |
| 2 | B2 | 90 | 10 | 0 | | |
| | B2A | 90 | 10 | 0 | | |
| | B2B | 90 | 10 | 0 | | |
| 3 | B3 | 80 | 20 | 0 | | |
| 4 | B4 | 70 | 30 | 0 | | |
| 5 | B5 | 60 | 40 | 0 | | |
| 6 | B6 | 50 | 50 | 0 | | |
| 7 | B7 | 40 | 60 | 0 | | |
| 8 | B8 | 95 | 0 | 5 | | |

Accordingly, varieties of concrete materials can be prepared with the method and system of the present invention. Totally 24 types of binders possible without changing the A/B ratio. Further, with introduction of 1 more A/B ratio, the total concrete types will increase to 48, considering the same binder content.

Further, the present invention discloses a system to produce a concrete material having optimized strength and particle packing properties. The system comprises a cement micro characterization unit, a pozzolanic micro characterization unit, at least one grinding unit and or a concrete mixing unit. The cement micro characterization unit provides at least one cementitious material having uniform strength from a plurality of starting cementitious materials. The pozzolanic micro characterization unit provides at least one pozzolanic material having uniform blain fineness from at least one starting pozzolanic material.

The at least one grinding unit is provided for grinding the said at least one cementitious material having uniform strength and the said at least one pozzolanic material having uniform blain fineness to get at least one cementitious material having a required Blaine fineness and at least one pozzolanic material having a required Blaine fineness. The concrete mixing unit is adapted to mix a material selected from at least one starting cementitious material, at least one cementitious material having uniform strength, at least one cementitious material having a required Blaine fineness, at least one starting pozzolanic material, at least one pozzolanic material having uniform blain fineness, at least one pozzolanic material having a required Blaine fineness, at least one aggregate material, at least one additive material or a mixture thereof.

The cement micro characterization unit includes a cement strength characterization unit, a cement mixing unit, and a cement Mode Average Particle Size (MAPS) characterization unit. The cement strength characterization unit includes a plurality of dividing units each dividing the plurality of starting cementitious materials into a first cementitious material having 28 days strength of 53-58 MPa, a second cementitious material having 28 days strength of 58-63 MPa, and a third cementitious material having 28 days strength of 63-70 MPa. The cement mixing unit includes a mixer to mix at least one of the first cementitious material, the second cementitious material, the third cementitious material in a ratio to get at least one cementitious material having uniform strength.

The cement Mode Average Particle Size (MAPS) characterization unit comprises a first grinding unit deployed for grinding the at least one cementitious material having uniform strength to a required cement Blaine fineness. Wherein, the required cement Blaine fineness is selected from a first cement Blaine fineness of 2500-3800 cm²/gm, a second cement Blaine fineness of 11000-15000 cm²/gm, a third cement Blaine fineness of 30000-50000 cm²/gm.

The pozzolanic micro characterization unit includes a pozzolanic Blaine fineness characterization unit, a pozzolanic mixing unit and a pozzolanic Mode Average Particle Size (MAPS) characterization unit. The pozzolanic Blaine fineness characterization unit includes a plurality of dividing units each dividing the plurality of starting pozzolanic materials into a first pozzolanic material having Blaine fineness of 2500-3500 cm²/gm, a second pozzolanic material having Blaine fineness of 3500-5000 cm²/gm, a third pozzolanic material having Blaine fineness of 5000-6500 cm²/gm. The pozzolanic mixing unit includes a mixer to mix at least one of the first pozzolanic material, the second pozzolanic material, the third pozzolanic material in a ratio to get at least one pozzolanic material having uniform Blaine fineness.

The pozzolanic Mode Average Particle Size (MAPS) characterization unit includes a second grinding unit deployed for grinding of at least one pozzolanic material having uniform Blaine fineness to a required Blaine fineness of at least one pozzolanic material. Wherein, the required Blaine fineness of at least one pozzolanic material is selected from a first Blaine fineness of 2500-6000 cm²/gm, a second Blaine fineness of 11000-15000 cm²/gm, and a third Blaine fineness of 30000-50000 cm²/gm.

The first grinding unit and the second grinding unit are one of a ball mill, a rod mill, a vibrating bed mill, or an agitator bed mill.

The concrete mixing unit is a site mixer, or a designed mixing cum pumping unit.

Wherein, at least one starting cementitious material, at least one cementitious material having uniform strength, at least one starting pozzolanic material, at least one pozzolanic material having uniform Blaine fineness, at least one aggregate material, at least one additive material, wherein each have a separate storage unit.

In an embodiment, the concrete material having optimized strength and particle packing properties and workable rheology is conveyed from the concrete mixing unit to a construction site through a screw conveyor system or a manual placement method.

To make a concrete mix with a pumpable rheology, the paste or mortar fraction has to be increased substantially to suit for the pumping operations. This mostly results in a concrete mix with an increased porosity, and/or water demand, and/or excessive dosing of admixtures/additives.

Accordingly, in another embodiment, the present invention also discloses an alternate system of conveying concrete, wherein, the concrete mixture is an optimized mixture which balances the workable rheology of the concrete as well as an ideal particle packing scenario from the macro-micro-nano lattice structure. Hence, the inventor stresses upon the usage of a screw conveyor system to convey concrete from the mixer to the desired location, wherein the comfortable workable rheology of the concrete is also maintained, which ensures highest level of quality, and achievement of the best strength and durability characteristics in the finished concrete

While specific language has been used to describe the disclosure, any limitations arising on account of the same are not intended. As would be apparent to a person in the art, various working modifications may be made to the method in order to implement the inventive concept as taught herein. The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A method to produce a concrete material having optimized strength and particle packing properties, wherein, the method comprises:
a micro characterization step of a plurality of starting cementitious materials, wherein, the said micro characterization step provides at least one cementitious material having uniform strength;
a micro characterization step of at least one starting pozzolanic material; wherein, the said micro characterization step provides at least one pozzolanic material having uniform blain fineness;
grinding the said at least one cementitious material having uniform strength and the said at least one pozzolanic material having uniform blain fineness to get at least one cementitious material having a required Blaine fineness and at least one pozzolanic material having a required Blaine fineness; and
preparing the said concrete material by mixing a material selected from at least one starting cementitious material, at least one cementitious material having uniform strength, at least one cementitious material having a required Blaine fineness, at least one starting pozzolanic material, at least one pozzolanic material having uniform blain fineness, at least one pozzolanic material having a required Blaine fineness, at least one aggregate material, at least one additive material or a mixture thereof.

2. The method as claimed in claim 1, wherein the micro characterization step of the plurality of starting cementitious materials comprises a strength characterization step of the plurality of starting cementitious materials, followed by a Mode Average Particle Size (MAPS) characterization step.

3. The method as claimed in claim 2, wherein the strength characterization of the plurality of starting cementitious materials comprises:
dividing the plurality of starting cementitious materials into a first cementitious material having 28 days strengths of 53-58 MPa, a second cementitious material having 28 days strengths of 58-63 MPa, and a third cementitious material having 28 days strengths of 63-70 MPa; and
mixing at least one of the first cementitious material, the second cementitious material, the third cementitious material in a ratio to get at least one cementitious material having uniform strength.

4. The method as claimed in claim 2 to claim 3, wherein the Mode Average Particle Size (MAPS) characterization step comprises a grinding of at least one cementitious material having uniform strength to a required cement Blaine fineness.

5. The method as claimed in claim 4, wherein the required cement Blaine fineness is selected from a first cement Blaine fineness of 2500-3800 cm²/gm, a second cement Blaine fineness of 11000-15000 cm²/gm, and optionally a third cement Blaine fineness of 30000-50000 cm²/gm.

6. The method as claimed in claim 1, wherein the micro characterization step of at least one starting pozzolanic material comprises a pozzolanic Blaine fineness characterization step, followed by a Mode Average Particle Size (MAPS) characterization step.

7. The method as claimed in claim 6, wherein the pozzolanic Blaine fineness characterization step comprises:
dividing at least one starting pozzolanic material into a first pozzolanic material having Blaine fineness of 2500-3500 cm²/gm, a second pozzolanic material having Blaine fineness of 3500-5000 cm²/gm, a third pozzolanic material having Blaine fineness of 5000-6500 cm²/gm; and
mixing the first pozzolanic material, the second pozzolanic material, the third pozzolanic material in a ratio to get at least one pozzolanic material having uniform Blaine fineness.

8. The method as claimed in claim 6 to claim 7, wherein the Mode Average Particle Size (MAPS) characterization step comprises a grinding of at least one pozzolanic material having uniform Blaine fineness to a required Blaine fineness of at least one pozzolanic material.

9. The method as claimed in claim 8, wherein the required Blaine fineness of at least one pozzolanic material is selected from a first Blaine fineness of 2500-6500 cm²/gm, a second Blaine fineness of 11000-15000 cm²/gm, and a third Blaine fineness of 30000-50000 cm²/gm.

10. The method as claimed in claim 1, wherein at least one starting pozzolanic material is selected from a fly ash material, a slag material, a volcanic ash material, metakaoline, ground quartz material, rice husk ash.

11. The method as claimed in claim 1, wherein the said at least one additive material is selected from a group of lignosulphonate, polycarboxylic acid, melamine, sulphonated naphthalene formaldehyde.

12. The method as claimed in claim 1, wherein the said at least one aggregate material is selected from one of a fine aggregate material, a coarse aggregate material, a silica coated coarse aggregate material, or a rapid coated aggregate material.

13. The method as claimed in claim 12, wherein the silica coated coarse aggregate material comprises coarse aggregate material coated with a slurry of silica to form a silica coating thereon.

14. The method as claimed in claim 13, wherein the slurry of silica is selected from a slurry of micro silica, or a slurry of nano silica.

15. The method as claimed in claim 12, wherein the rapid coated aggregate material comprises a mixture of a bone dried aggregate material coated with a slurry made of at least one starting cementitious material, at least one cementitious material having uniform strength, at least one starting pozzolanic material, at least one pozzolanic material having uniform Blaine fineness, and at least one additive material and mixing water.

16. The method as claimed in claim 15, wherein the said bone dried aggregate material is selected from one of a fine aggregate material, a coarse aggregate material, a silica coated coarse aggregate material.

17. A system to produce a concrete material having optimized strength and particle packing properties, wherein, the system comprises:
a cement micro characterization unit for a plurality of starting cementitious materials, wherein, the said cement micro characterization unit provides at least one cementitious material having uniform strength;
a pozzolanic micro characterization unit for at least one starting pozzolanic material;
wherein, the said pozzolanic micro characterization unit provides at least one pozzolanic material having uniform blain fineness;
at least one grinding unit for grinding the said at least one cementitious material having uniform strength and the said at least one pozzolanic material having uniform blain fineness to get at least one cementitious material having a required Blaine fineness and at least one pozzolanic material having a required Blaine fineness; and
a concrete mixing unit adapted to mix a material selected from at least one starting cementitious material, at least one cementitious material having uniform strength, at least one cementitious material having a required Blaine fineness, at least one starting pozzolanic material, at least one pozzolanic material having uniform blain fineness, at least one pozzolanic material having a required Blaine fineness, at least one aggregate material, at least one additive material or a mixture thereof.

18. The system as claimed in claim 17, wherein the cement micro characterization unit comprises:
a cement strength characterization unit having a plurality of dividing units each dividing the plurality of starting cementitious materials into a first cementitious material having 28 days strength of 53-58 MPa, a second cementitious material having 28 days strength of 58-63 MPa, a third cementitious material having 28 days strength of 63-70 MPa;
a cement mixing unit to mix at least one of the first cementitious material, the second cementitious material, the third cementitious material in a ratio to get at least one cementitious material having uniform strength; and
a cement Mode Average Particle Size (MAPS) characterization unit.

19. The system as claimed in claim 18, wherein the cement Mode Average Particle Size (MAPS) characterization unit comprises a first grinding unit deployed for grinding the at least one cementitious material having uniform strength to a required cement Blaine fineness.

20. The system as claimed in claim 19, wherein the required cement Blaine fineness is selected from a first cement Blaine fineness of 2500-3800 cm²/gm, a second cement Blaine fineness of 11000-15000 cm²/gm, a third cement Blaine fineness of 30000-50000 cm²/gm.

21. The system as claimed in claim 17, wherein the pozzolanic micro characterization unit comprises:
a pozzolanic Blaine fineness characterization unit having a plurality of dividing units each dividing the plurality of starting pozzolanic materials into a first pozzolanic material having Blaine fineness of 2500-3500 cm²/gm, a second pozzolanic material having Blaine fineness of 3500-5000 cm²/gm, a third pozzolanic material having Blaine fineness of 5000-6500 cm²/gm;
a pozzolanic mixing unit to mix at least one of the first pozzolanic material, the second pozzolanic material, the third pozzolanic material in a ratio to get at least one pozzolanic material having uniform Blaine fineness; and
a pozzolanic Mode Average Particle Size (MAPS) characterization unit.

22. The system as claimed in claim 21, wherein the pozzolanic Mode Average Particle Size (MAPS) characterization unit comprises a second grinding unit deployed for grinding of at least one pozzolanic material having uniform Blaine fineness to a required Blaine fineness of at least one pozzolanic material.

23. The system as claimed in claim 22, wherein the required Blaine fineness of at least one pozzolanic material is selected from a first Blaine fineness of 2500-6000 cm²/gm, a second Blaine fineness of 11000-15000 cm²/gm, and a third Blaine fineness of 30000-50000 cm²/gm.

24. The system as claimed in claim 19 to claim 22, wherein the first grinding unit and the second grinding unit are one of a ball mill, a rod mill, a vibrating bed mill, or an agitator bed mill.

25. The system as claimed in claim 17, wherein the concrete mixing unit is a site mixer, or a designed mixing cum pumping unit.

26. The system as claimed in claim 17, wherein at least one starting cementitious material, at least one cementitious material having uniform strength, at least one starting pozzolanic material, at least one pozzolanic material having uniform Blaine fineness, at least one aggregate material, at least one additive material, wherein each have a separate storage unit.

27. The system as claimed in claim 17, wherein the concrete material having optimized strength and particle packing properties and workable rheology is conveyed from the concrete mixing unit to a construction site through a screw conveyor system.
